(19) United States
(12) Patent Application Publication
(10) Pub. No.: US 2025/0237438 A1
(43) Pub. Date: Jul. 24, 2025

(54) Cylindrical heating apparatus for aluminum foil annealing furnaces

(71) Applicant: Ningbo Sachsen Industrial Technology Co., Ltd., Ningbo (CN)

(72) Inventors: Wanglin ZHENG, Ningbo (CN); Jiuxin LIU, Ningbo (CN)

(73) Assignee: Ningbo Sachsen Industrial Technology Co., Ltd., Ningbo (CN)

(21) Appl. No.: 19/035,615

(22) Filed: Jan. 23, 2025

(30) Foreign Application Priority Data
Jan. 23, 2024 (CN) 2024100930536

(51) Int. Cl. F27D 7/02; F27D 7/04

(52) U.S. Cl. CPC F27D 7/02; F27D 7/04; F27D 2007/023; F27D 2007/045; F27M 2001/012; F27M 2001/1565; F27M 2003/01

(57) ABSTRACT

The present invention discloses a cylindrical heating apparatus for aluminum foil annealing furnaces. During use, a fan sends air through an air inlet into the cylindrical shell, where the air flows circumferentially along the inner wall of the cylindrical shell, a guide plate directs a portion of the air to middle areas of the cylindrical shell to enhance the heat convection exchange between heating cores located in the middle areas of the cylindrical shell and the air, thereby improving the heating efficiency of the heating cores.

### INCORPORATION BY REFERENCE

This application claims the benefit of priority from China Patent Application No. 2024100930536 filed on Jan. 23, 2024, the contents of which are hereby incorporated by reference in their entirety.

### TECHNICAL FIELD

The present invention relates to the technical field of heaters, in particular to a cylindrical heater for aluminum foil annealing furnaces.

### BACKGROUND TECHNOLOGY

Aluminum foil annealing furnace is a kind of equipment that heats the air through resistance belt, and the fan brings the heated air into the furnace through pipeline flow channels. The heated air heats the aluminum foil in the furnace, and the air after absorbing heat enters the fan and circulates into the heater. In this way, the air circulates and controls the temperature and time to achieve aluminum foil annealing.

The heaters currently used in aluminum foil annealing furnaces are generally divided into two types:
the first type is a single heating core arranged in multiple groups and built into the air ducts on both sides of the furnace. The fan built into the annealing furnace rotates, and the fluid flows in the air duct equipped with the heating core to take away the heat generated by the heating core and bring the aluminum coils that need to be heated into the furnace. This type of aluminum foil annealing furnace occupies a large area, has a large overall volume, and achieves a low utilization rate of effective loading space, and a low heat conversion rate. It requires a high-power fan to meet the process production requirements and temperature uniformity requirements. The equipment is expensive, and the maintenance and replacement of the heating core is inconvenient; and
the second type is that the heating core and the fan are placed outside the furnace and on the top of the furnace. The heating core is built into a square chamber. The air inlet of the fan enters the heating chamber from the side, passes through the heating zone, exits the heating chamber from the opposite side, and then enters the circulation pipeline. This heater has a complex structure, high manufacturing cost, non-compact structure, large heat dissipation area, short heat exchange path, and low heat exchange efficiency. Since the air inlet of the fan is small and the heating chamber is large, it is necessary to design a multi-layer guide and air distribution structure, which has large air resistance and large air pressure loss.

### SUMMARY OF THE INVENTION

The present invention provides a cylindrical heater for aluminum foil annealing furnaces, which allows air to flow circumferentially along the inner wall of the cylindrical shell after entering the cylindrical shell, and guides part of the air to the areas where the heating cores are located in the cylindrical shell to increase the heat convection exchange between the heating cores and the flowing air.

The present invention provides a cylindrical heater for aluminum foil annealing furnaces, comprising:
a cylindrical shell which comprises an air inlet and an air outlet, wherein the air inlet is arranged on an upper peripheral wall of the cylindrical shell, the air outlet is arranged at a bottom portion of the cylindrical shell, and top portions of the cylindrical shell are closed;
heating cores, wherein the heating cores are arranged in the cylindrical shell, the heating cores are in rod-shaped structures, axes of the heating cores are parallel to an axis of the cylindrical shell, and the heating cores are circumferentially spaced around the axis of the cylindrical shell;
a fan, used for supplying air into the cylindrical shell through the air inlet, wherein the air entering the cylindrical shell through the air inlet flows circumferentially along an inner circumferential wall of the cylindrical shell; and
flow guide members arranged on the inner circumferential wall of the cylindrical shell, wherein the flow guide members are circumferentially spaced around the axes of the cylindrical heating core; the flow guide members comprise flow guide plates; and the flow guide plates are used to guide at least a portion of the air that flows circumferentially along the inner circumferential wall of the cylindrical shell and enters the cylindrical shell from the air inlet to middle areas of the cylindrical shell.

Preferably, side edges of the flow guide plates of the flow guide members are connected to inner walls of the cylindrical heating cores, and another side edges of the flow guide plates of the flow guide members are directed toward the middle areas of the cylindrical shell.

Preferably, the side edges of the flow guide plates of the flow guide members are all provided with openings for gas to pass through.

Preferably, the cylindrical heater for aluminum foil annealing furnaces further comprises an outer cylinder, the cylindrical shell is arranged in the outer cylinder, the outer cylinder and the cylindrical shell are connected by connecting parts, and between the outer cylinder and the cylindrical shell are filled heat insulation materials.

Preferably, at a bottom portion of the cylindrical shell is arranged a truncated cone-shaped shell, the truncated cone-shaped shell is a structure with a larger upper portion and a smaller lower portion, upper end portions of the truncated cone-shaped shell are connected to bottom portions of the cylindrical shell, and lower end portions of the truncated cone-shaped shell form the air outlet.

Preferably, quantity of the flow guide members is two, the flow guide plates of the flow guide members are rotationally connected an inner wall of the cylindrical shell, rotation axes of the flow guide plates are parallel to the axis of the cylindrical shell, and the flow guide plates are provided with openings for gas to pass through;
heating cores are rotationally arranged in the cylindrical shell, gear rings are arranged on outer walls of the heating cores, a gear is rotationally arranged in the cylindrical shell, the gear is arranged coaxially with the cylindrical shell, a motor for driving the gear to rotate is arranged outside the cylindrical shell, the gear is meshed with the gear rings of the heating cores, and when the gear rotates, the heating cores are driven to rotate;
a protruding column is fixedly provided on one end surface of the gear, a cable is passed around and tensioned on the protruding column, two end portions of the cable are respectively connected to the side edges of the two flow guide plates away from the inner wall of the cylindrical shell, surfaces of the two flow guide plates away from the protruding column are respectively connected to end portions of two tension springs, and another end portions of the two tension springs are respectively connected to the inner wall of the cylindrical shell; and
when the gear rotates, the gear drives all the heating cores to rotate, and at the same time, the protruding column moves circumferentially around the axis of the cylindrical shell, the convex column drives the two flow guide plates to rotate by pressing the cable, and the two tension springs are respectively used to apply reset forces to the two flow guide plates.

One or more technical solutions provided in the present invention have at least following technical effects or advantages:

When the cylindrical heater for aluminum foil annealing furnaces of the present invention is in use, the fan sends air into the cylindrical shell through the air inlet, and the air flows circumferentially along the inner wall of the cylindrical shell. The guide plate guides part of the air to the middle area of the cylindrical shell to enhance the heat convection exchange between the heating core located in the cylindrical shell and the air, thereby improving the heating efficiency of the heating core on the airflow.

### BRIEF DESCRIPTION OF THE DRAWINGS

In order to more clearly illustrate the technical solutions in the embodiments of the present invention, the following briefly introduces the drawings required for use in the description of the embodiments. Obviously, the drawings described below are only some embodiments of the present invention. For ordinary technicians in this field, other drawings can be obtained based on these drawings without creative work.

FIG. 1 is a schematic diagram of the structure of a first embodiment.

FIG. 2 is a cross-sectional view in a “B-B” direction in FIG. 1.

FIG. 3 is a cross-sectional view in an “A-A” direction in FIG. 1.

FIG. 4 is a schematic diagram of the structure of a cylindrical shell in the first embodiment.

FIG. 5 is a schematic diagram of the structure of a second embodiment.

### SPECIFIC EMBODIMENTS

The following will be combined with the drawings in embodiments of the present invention to clearly and completely describe the technical solutions in the embodiments of the present invention. Obviously, the described embodiments are only part of the embodiments of the present invention, not all of the embodiments. Based on the embodiments in the present invention, all other embodiments obtained by ordinary technicians in this field without creative work are within the scope of protection of this application.

It should be noted that the terms “first”, “second”, etc. in the specification and claims of the present invention and the above-mentioned drawings are used to distinguish similar objects, and are not necessarily used to describe a specific order or sequence. It should be understood that the data used in this way can be interchanged where appropriate, so that the embodiments of the present invention described herein can be implemented in an order other than those illustrated or described herein. In addition, the terms “comprising” and “including” and any variations thereof are intended to cover non-exclusive inclusions, for example, a process, method, system, product, or server that includes a series of steps or units is not necessarily limited to those steps or units that are clearly listed, but may include other steps or modules that are not clearly listed or inherent to these processes, methods, products, or devices.

### Embodiment 1

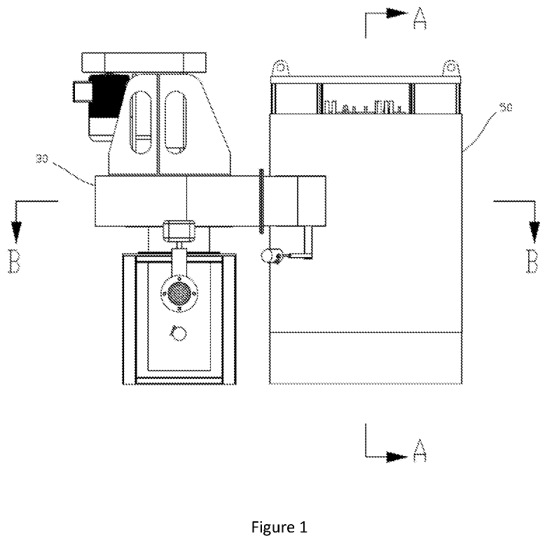

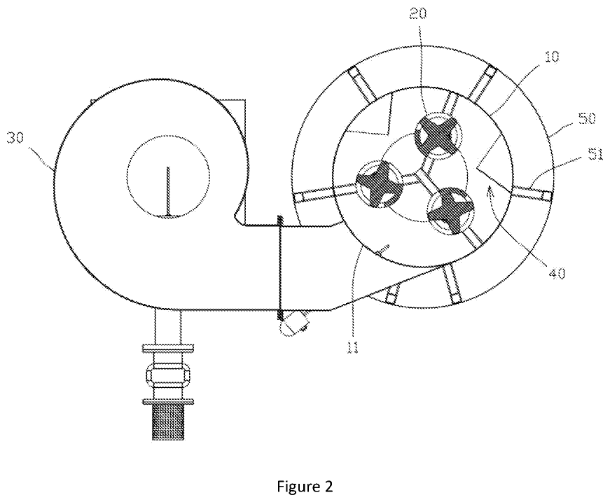

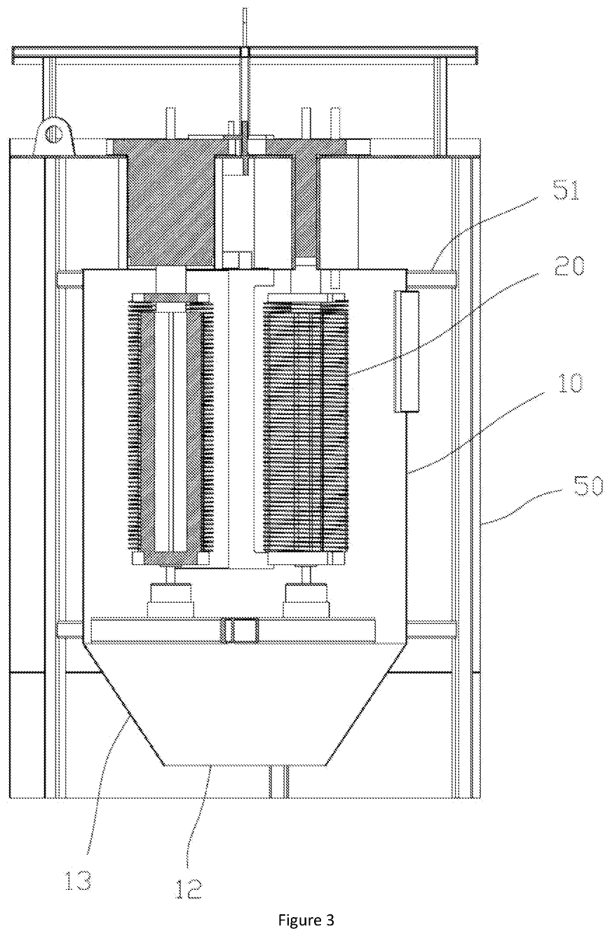

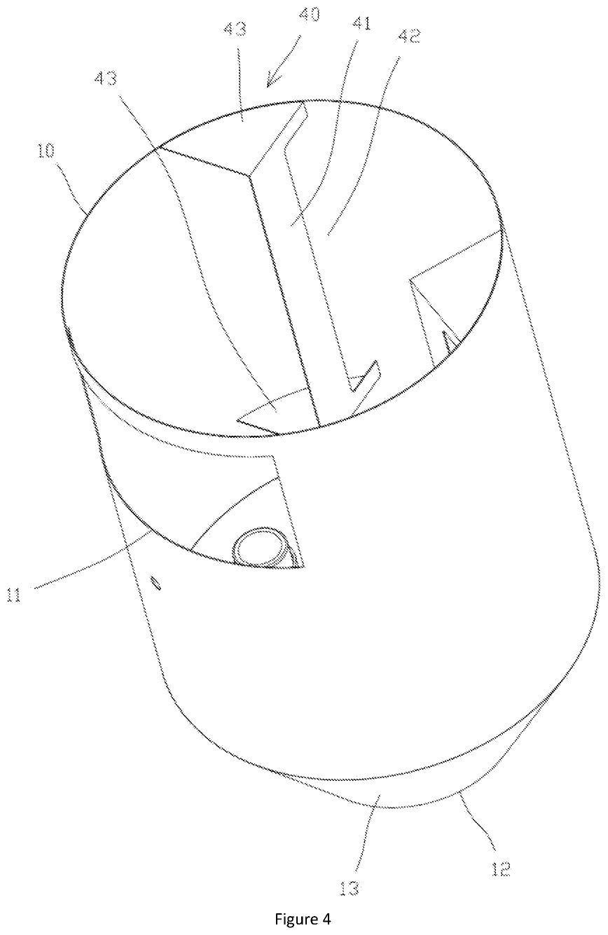

As shown in FIGS. 1-4, an embodiment of the present invention provides a cylindrical heater for aluminum foil annealing furnaces, comprising a cylindrical shell 10, heating cores 20, a fan 30 and flow guide members 40, wherein
the cylindrical shell 10 comprises an air inlet 11 and an air outlet 12, wherein the air inlet 11 is arranged on an upper peripheral wall of the cylindrical shell 10, the air outlet 12 is arranged at a bottom portion of the cylindrical shell 10, and top portions of the cylindrical shell 10 are closed, so that after the air enters the cylindrical shell 10 from the air inlet 11, the air flows circumferentially along an inner wall of the cylindrical shell 10 and gradually flows downward, and finally flows out from the air outlet 12;
the heating cores 20 are arranged in the cylindrical shell 10, the heating cores 20 are in rod-shaped structures, axes of the heating cores 20 are parallel to an axis of the cylindrical shell 10, the heating cores 20 are circumferentially spaced around the axis of the cylindrical shell 10, and the heating cores 20 are spaced apart from the inner wall of the cylindrical shell 10;
the fan 30 is used for supplying air into the cylindrical shell 10 through the air inlet 11, after the air delivered by the fan 30 enters the cylindrical shell 10 through the air inlet 11, the air flows circumferentially along the inner wall of the cylindrical shell 10, that is, the fan 30 delivers air along the tangential direction of the inner wall of the cylindrical shell 10; and
the flow guide members 40 are arranged on the inner circumferential wall of the cylindrical shell 10, wherein the flow guide members 40 are circumferentially spaced around the axes of the cylindrical heating core 10; the flow guide members 40 comprise flow guide plates 41, the flow guide members 40 comprises flow guide plates 41 and pairs of end plates 43 spaced apart in an axial direction of the cylindrical shell 10, the end plates 43 are perpendicular to the axial direction of the cylindrical shell 10, and the upper and lower end portions of the flow guide plates 41 are respectively connected to the two end plates 43; the flow guide plates 41 are used to guide at least a portion of the air that flows circumferentially along the inner circumferential wall of the cylindrical shell 10 and enters the cylindrical shell 10 from the air inlet 11 to middle areas of the cylindrical shell 10.

Side edges of the flow guide plates 41 of the flow guide members 40 are connected to inner walls of the cylindrical heating cores 10, and another side edges of the flow guide plates 41 of the flow guide members 40 are directed toward the middle areas of the cylindrical shell 10, so that a part of the air flowing along the inner wall of the cylindrical shell 10 can be guided by the flow guide plates 41 to positions of the heating cores 20, thereby enhancing the convection heat exchange between the heating cores 20 and the air.

Side edges of the flow guide plates of the flow guide members 40 are all provided with openings 42 for gas to pass through, so that a part of the air flowing along the inner wall of the cylindrical shell 10 can be guided by the flow guide plates 41 to positions of the heating cores 20, while the other part of the air flowing along the inner wall of the cylindrical shell 10 can continue to flow forward through the openings 42 without being blocked by the flow guide plates 41, so that the air flowing circumferentially along the inner wall of the cylindrical shell 10 can touch the flow guide members 40, each flow guide member 40 can guide a part of the air to the middle areas of the cylindrical shell 10, the airflow is more evenly distributed when flowing in the cylindrical shell 10, which is more conducive to the uniform heating of the airflow by the heating cores 20.

The cylindrical heater for aluminum foil annealing furnaces further comprises an outer cylinder 50, the cylindrical shell 10 is arranged in the outer cylinder 50, the outer cylinder 50 and the cylindrical shell 10 are connected by connecting parts, the connecting parts 51 are connected between inner walls of the outer cylinder 50 and outer walls of the cylindrical shell 10, and between the outer cylinder and the cylindrical shell are filled heat insulation materials to keep the cylindrical shell 10 warm.

At a bottom portion of the cylindrical shell 10 is arranged a truncated cone-shaped shell 13, the truncated cone-shaped shell 13 is a structure with a larger upper portion and a smaller lower portion, upper end portions of the truncated cone-shaped shell 13 are connected to bottom portions of the cylindrical shell 10, lower end portions of the truncated cone-shaped shell 13 form the air outlet, in this way, the air outlet 12 is smaller than the inner cavity of the cylindrical shell 10, thereby accelerating the flow rate of the airflow when it flows out from the air outlet 12.

### Embodiment 2

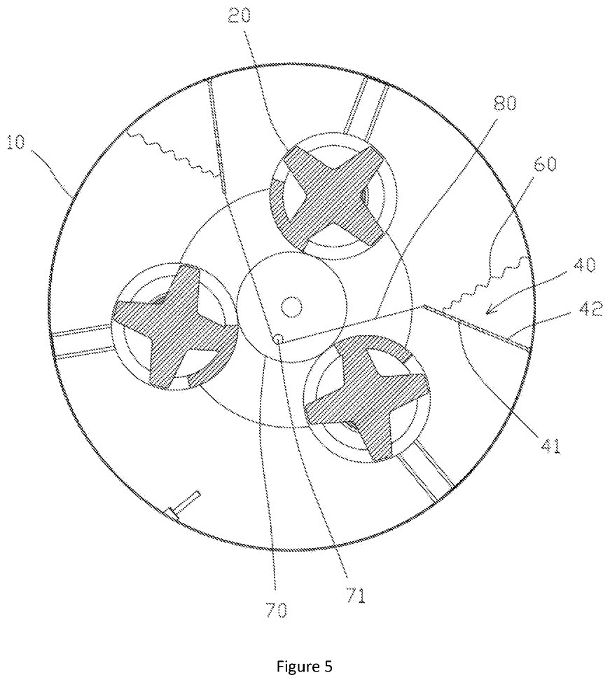

As shown in FIG. 5, quantity of the flow guide members 40 is two, the flow guide plates 41 of the flow guide members 40 are rotationally connected an inner wall of the cylindrical shell 10, other sides of the flow guide members 40 are free sides, rotation axes of the flow guide plates 41 are parallel to the axis of the cylindrical shell 10, and the flow guide plates 41 are provided with openings 42 for gas to pass through.

There are three heating cores 20, and the three heating cores 20 are rotationally arranged in the cylindrical shell 10, axes of the heating cores 20 are parallel to the axis of the cylindrical shell 10, the three heating cores 20 are evenly spaced around the axis of the cylindrical shell 10, gear rings are fixedly arranged on outer walls of the heating cores 20 and coaxially arranged with respective heating cores 20, the heating cores 20 are electric heating structures and connected to the power supply line through a rotating electrical connector, so that the power supply line supplies power to the heating cores 20, a gear 70 is rotationally arranged in the cylindrical shell 10, the gear 70 is arranged coaxially with the cylindrical shell 10, a motor for driving the gear 70 to rotate is arranged outside the cylindrical shell 10, the motor is located above the cylindrical shell 10, an output shaft of the motor passes through the upper cover of the cylindrical shell 10 and extends into the cylindrical shell 10 and is coaxially connected to the gear 70, the gear 70 is meshed with the gear rings of the heating cores 20, and when the gear 70 rotates, the heating cores 20 are driven to rotate.

A protruding column 71 is fixedly provided on one end surface of the gear 70, a cable 80 is passed around and tensioned on the protruding column 71, two end portions of the cable 80 are respectively connected to the side edges of the two flow guide plates 41 away from the inner wall of the cylindrical shell 10, surfaces of the two flow guide plates 41 away from the protruding column 71 are respectively connected to end portions of two tension springs 60, and another end portions of the two tension springs 60 are respectively connected to the inner wall of the cylindrical shell 10; and the two tension springs 60 respectively apply a rotational force to the two flow guide plates 41 in a direction close to the inner wall of the cylindrical shell 10, and when the protruding column 71 moves with the rotation of the gear 70, the protruding column 71 applies a rotational force to the two flow guide plates 41 through the cable 80 to overcome the tension direction of the tension springs 60, so that when the protruding column 71 continues to rotate with the gear 70, the two flow guide plates 41 can swing back and forth.

When the gear 70 rotates, the gear 70 drives all the heating cores 20 to rotate, and at the same time, the protruding column 71 moves circumferentially around the axis of the cylindrical shell 10, the protruding column 71 drives the two flow guide plates 41 to rotate by pressing the cable 80, and the two tension springs 60 are respectively used to apply reset forces to the two flow guide plates 41, so that when the protruding column 71 rotates continuously with the gear 70, the two flow guide plates 41 can swing back and forth. In this way, the reciprocating swing of the two flow guide plates 41 can guide the wind flowing circumferentially along the inner wall of the cylindrical shell 10 to different angles. At the same time, each of the heating cores 20 is rotating, so that the airflow and the heating cores 20 can contact more evenly, making the heating efficiency of the heating cores 20 higher.

It should be noted that the above sequence of the embodiments of the present invention is only for description and does not represent the advantages and disadvantages of the embodiments. And the above describes some specific embodiments of the present specification. Other embodiments are within the scope of the attached claims. In some cases, the actions or steps recorded in the claims can be performed in a different order from that in the embodiment and still achieve the desired results. In addition, the process depicted in the drawings does not necessarily require the specific order or continuous order shown to achieve the desired results. In some embodiments, multi-tasking and parallel processing are also possible or may be advantageous.

The above descriptions are only some preferred embodiments of the present invention and are not intended to limit the present invention. Any modifications, equivalent replacements, improvements, etc. made within the spirit and principles of the present invention shall be included in the protection scope of the present invention.

This specification and the accompanying drawings are merely exemplary illustrations of the present invention, and are deemed to have covered any and all modifications, variations, combinations or equivalents within the scope of the present invention. Obviously, those skilled in the art may make various changes and modifications to the present invention without departing from the scope of the present invention. Thus, if these modifications and variations of the present invention fall within the scope of the present invention and its equivalents, the present invention is intended to include these changes and variations.

1. A cylindrical heater for aluminum foil annealing furnaces, comprising:
a cylindrical shell (10) which comprises an air inlet (11) and an air outlet (12), wherein the air inlet (11) is arranged on an upper peripheral wall of the cylindrical shell (10), the air outlet (12) is arranged at a bottom portion of the cylindrical shell (10), and top portions of the cylindrical shell (10) are closed;
heating cores, wherein the heating cores (20) are arranged in the cylindrical shell (10), the heating cores (20) are in rod-shaped structures, axes of the heating cores (20) are parallel to an axis of the cylindrical shell (10), and the heating cores (20) are circumferentially spaced around the axis of the cylindrical shell (10);
a fan (30), used for supplying air into the cylindrical shell (10) through the air inlet (11), wherein the air entering the cylindrical shell (10) through the air inlet (11) flows circumferentially along an inner circumferential wall of the cylindrical shell (10); and
flow guide members (40) arranged on the inner circumferential wall of the cylindrical shell (10), wherein the flow guide members (40) are circumferentially spaced around the axes of the cylindrical heating core (10); the flow guide members (40) comprise flow guide plates (41); the flow guide plates (41) are used to guide at least a portion of the air that flows circumferentially along the inner circumferential wall of the cylindrical shell (10) and enters the cylindrical shell (10) from the air inlet (11) to middle areas of the cylindrical shell (10).

2. The cylindrical heater for aluminum foil annealing furnaces according to claim 1, wherein side edges of the flow guide plates (41) of the flow guide members (40) are connected to inner walls of the cylindrical heating cores (10), and another side edges of the flow guide plates (41) of the flow guide members (40) are directed toward the middle areas of the cylindrical shell (10).

3. The cylindrical heater for aluminum foil annealing furnaces according to claim 2, wherein the side edges of the flow guide plates (41) of the flow guide members (40) are all provided with openings (42) for gas to pass through.

4. The cylindrical heater for aluminum foil annealing furnaces according to claim 3, further comprising an outer cylinder (50), the cylindrical shell (10) is arranged in the outer cylinder (50), the outer cylinder (50) and the cylindrical shell (10) are connected by connecting parts, and between the outer cylinder (50) and the cylindrical shell (10) are filled heat insulation materials.

5. The cylindrical heater for aluminum foil annealing furnaces according to claim 4, wherein at a bottom portion of the cylindrical shell (10) is arranged a truncated cone-shaped shell (13), the truncated cone-shaped shell (13) is a structure with a larger upper portion and a smaller lower portion, upper end portions of the truncated cone-shaped shell (13) are connected to bottom portions of the cylindrical shell (10), and lower end portions of the truncated cone-shaped shell (13) form the air outlet (12).

6. The cylindrical heater for aluminum foil annealing furnaces according to claim 1, wherein quantity of the flow guide members (40) is two, the flow guide plates (41) of the flow guide members (40) are rotationally connected an inner wall of the cylindrical shell (10), rotation axes of the flow guide plates (41) are parallel to the axis of the cylindrical shell (10), and the flow guide plates (41) are provided with openings (42) for gas to pass through;
heating cores (20) are rotationally arranged in the cylindrical shell (10), gear rings are arranged on outer walls of the heating cores (20), a gear (70) is rotationally arranged in the cylindrical shell (10), the gear (70) is arranged coaxially with the cylindrical shell (10), a motor for driving the gear (70) to rotate is arranged outside the cylindrical shell (10), the gear (70) is meshed with the gear rings of the heating cores (20), and when the gear (70) rotates, the heating cores (20) are driven to rotate;
a protruding column (71) is fixedly provided on one end surface of the gear (70), a cable (80) is passed around and tensioned on the protruding column (71), two end portions of the cable (80) are respectively connected to the side edges of the two flow guide plates (41) away from the inner wall of the cylindrical shell (10), surfaces of the two flow guide plates (41) away from the protruding column (71) are respectively connected to end portions of two tension springs (60), and another end portions of the two tension springs (60) are respectively connected to the inner wall of the cylindrical shell (10); and
when the gear (70) rotates, the gear (70) drives all the heating cores (20) to rotate, and at the same time, the protruding column (71) moves circumferentially around the axis of the cylindrical shell (10), the convex column (71) drives the two flow guide plates (41) to rotate by pressing the cable (80), and the two tension springs (60) are respectively used to apply reset forces to the two flow guide plates (41).
